(19) United States
(12) Patent Application Publication
(10) Pub. No.: US 2010/0057910 A1
(43) Pub. Date: Mar. 4, 2010

(54) Concept for trusting client-side storage and distribution of asynchronous includes in an application server environment

(75) Inventors: Todd E. Kaplinger, Raleigh, NC (US); Erik John Burckart, Raleigh, NC (US); Rohit Dilip Kelapure, Morrisville, NC (US); Erinn Elizabeth Koonce, Durham, NC (US); Maxim Avery Moldenhauer, Durham, NC (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/202,459

(22) Filed: Sep. 2, 2008

(51) Int. Cl. G06F 15/173

(52) U.S. Cl. 709/225

(57) ABSTRACT

The ability to leverage a publish/subscribe functionality in an application server environment has allowed the storage of cached entries to be stored over multiple clients rather than on a single application server, freeing up valuable resources. However, in this arrangement it is not possible for the originating server to validate shared content originating from client-side storage. The present invention provides a system and method for securing and validating content from asynchronous include request by allowing a subscribing client to set trusted clients from which they will accept content.

### FIELD OF THE INVENTION

The present disclosure relates generally to a method and system for securing and validating the client-side storage of content from asynchronous include requests in an application server environment.

### DESCRIPTION OF BACKGROUND

In the traditional application server environment, entire pages are cached by an application server and each client must return to the application server to obtain these pages. With the advent of new Web 2.0 technologies, pages are becoming increasingly fragmented, resulting in an increase in the number of cached entries and a decrease in the likelihood that any of those cached fragments will be requested again. By leveraging a publish/subscribe environment, these cached entries can be stored on multiple clients instead of a single server. This frees up server resources and allows the server to act more like a proxy, facilitating indirect communication between multiple clients, than a storage mechanism. Clients have also benefited from this arrangement since there is no longer a need to constantly poll the server for results. A client subscribes to content via an asynchronous include/request, and once subscribed clients are automatically notified when results become available. No additional software is required on the client end as known technologies like Dojo already contain publication/subscribe functionality and dojo.storage and can be utilized to provide a unified method for maintaining cached content on the client.

The prior art method for client-side storage and distribution of asynchronous includes is demonstrated in FIG. 3. In step 301, Client A subscribes to receive the content of asynchronous include result 1. In step 302, Client B also subscribes to receive the content of result 1. An application server, in step 303, processes the asynchronous include result 1 request and sends the content of result 1 to a results server. In step 304, the results server receives result 1 and distributes the content to all subscribed clients (Clients A & B). The content of result 1 is no longer stored on the results server. In step 305, Client C subscribes to receive result 1. In step 306, the results server recognizes that result 1 has already been requested and polls all clients subscribed to it. Client A, in step 307, responds that it still has result 1 and sends the content to the result server. The result server in turns forwards the content of result 1 to Client C via the results server. A serious drawback to this method is that the client should never be considered trusted when it comes to sharing data with other clients since the originating server cannot validate the origin of the content or whether the original content has been modified. Therefore systems and methods for securing and validating client-side storage and distribution of content from asynchronous includes are needed.

### SUMMARY OF THE INVENTION

The present invention provides validated read only cache content for client-side storage and distribution of asynchronous includes by allowing a client in an application server environment to designate trusted clients from which they will accept the content of an asynchronous include request. The invention comprises an application server environment comprising an application server, a results server and one or more client devices. In the application server environment each client maintains a connection to the results server and the results server functions as a proxy for subscription and publication of asynchronous includes between clients.

In the present invention, a client designates other clients in an application server environment that it will trust to receive content from an asynchronous include request. The logic for determining whether a client is trusted is maintained on the results server.

When a client subscribes to the content of an asynchronous include, the request is sent to a results server. The results server identifies one or more clients in the application server environment who have previously subscribed to and have cached the content in local storage (publishing client). The results server then verifies whether the publishing client is a trusted client of the subscribing client. If the publishing client is a trusted client of the subscribing client, the publishing client sends the content to the results server and the results server publishes the content to the subscribing client. If a trusted client with the requested content cannot be found, the results server sends the request to an application server. The application server processes the request and sends the content to the subscribing client to the results server and the results server publishes the content to the subscribing client. After the results server has published the content to the subscribing client, the content is no longer stored on the results server.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention it is now possible to secure and validate client-side storage of content from asynchronous include requests in an application server environment.

### BRIEF DESCRIPTION OF THE DRAWINGS

The subject matter which is regarded as the invention is particularly pointed out and distinctly claimed in the claim at the conclusion of the specification. The foregoing and other objects, features, and advantages of the invention are apparent from the following detailed description taken in conjunction with the accompanying drawings in which:

FIG. 1 is a block diagram depicting an exemplary operating environment for implementation of certain exemplary embodiments.

FIG. 2 is a block diagram illustrating a general computer environment of a client computer for use with certain exemplary embodiments.

FIG. 3 is a block diagram illustrating prior art methods for client-side storage and distribution of asynchronous includes.

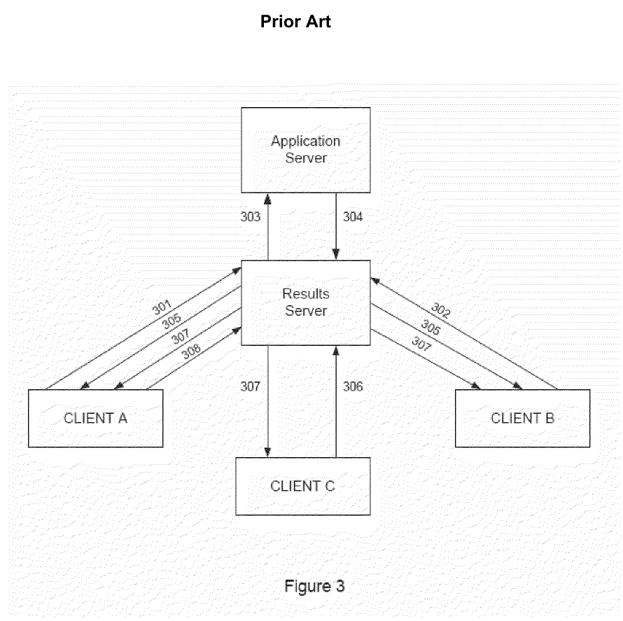

FIG. 4 is a flow chart depicting a method for securing and validating client-side storage and distribution of an asynchronous include request in an application server environment, in accordance with certain exemplary embodiments.

The detailed description explains the preferred embodiments of the invention, together with advantages and features, by way of example with reference to the drawings.

### DETAILED DESCRIPTION OF THE INVENTION

The invention is directed to a method for securing and validating client-side storage and distribution of asynchronous includes in an application server environment. The invention allows a client to validate content received from other clients in an application server environment. Turning now to the drawings, in which like numerals indicate like elements throughout the figures, exemplary embodiments of the invention are described in detail.

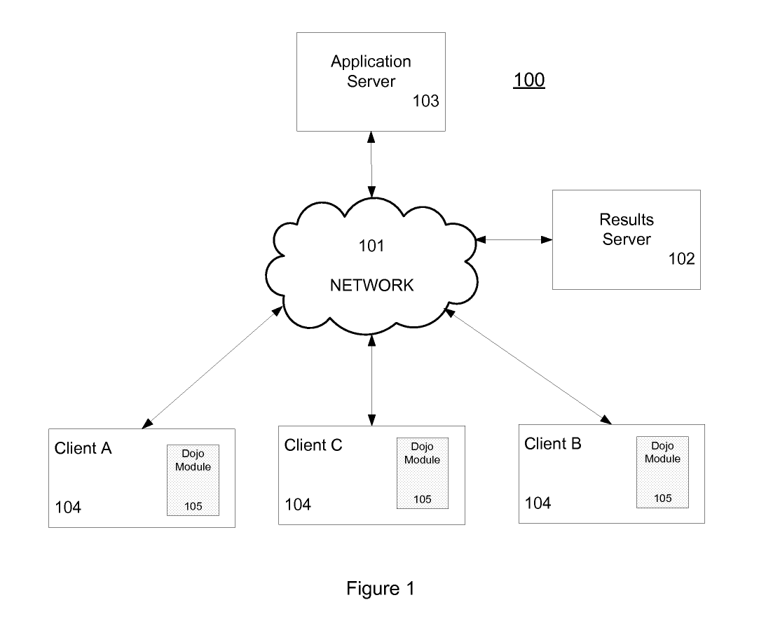

FIG. 1 is a block diagram depicting an exemplary operating environment 100 for implementation of certain exemplary embodiments of the invention. Client devices 104, a results server 102 and application server 103 are interconnected via a network 101. The network includes a wired or wireless telecommunications means by which client devices 104, results server 102 and application server 103 can exchange data. For example, the network 101 can include a local area network (“LAN”), a wide area network (“WAN”), an intranet, an Internet, or any combination thereof. The terms “data” and “information” are used interchangeably herein to refer to text, images, audio, video, or any other forms of information that can exist in a computer-based environment, whether readable by a computer or a person.

Each client device 104 can be any device capable of transmitting and receiving data over the network 101. For example, each client device 104 can be a desktop computer, a laptop computer, a wireless network device, such as a personal digital assistant (PDA), a handheld computer, or any other wired or wireless, processor-driven device.

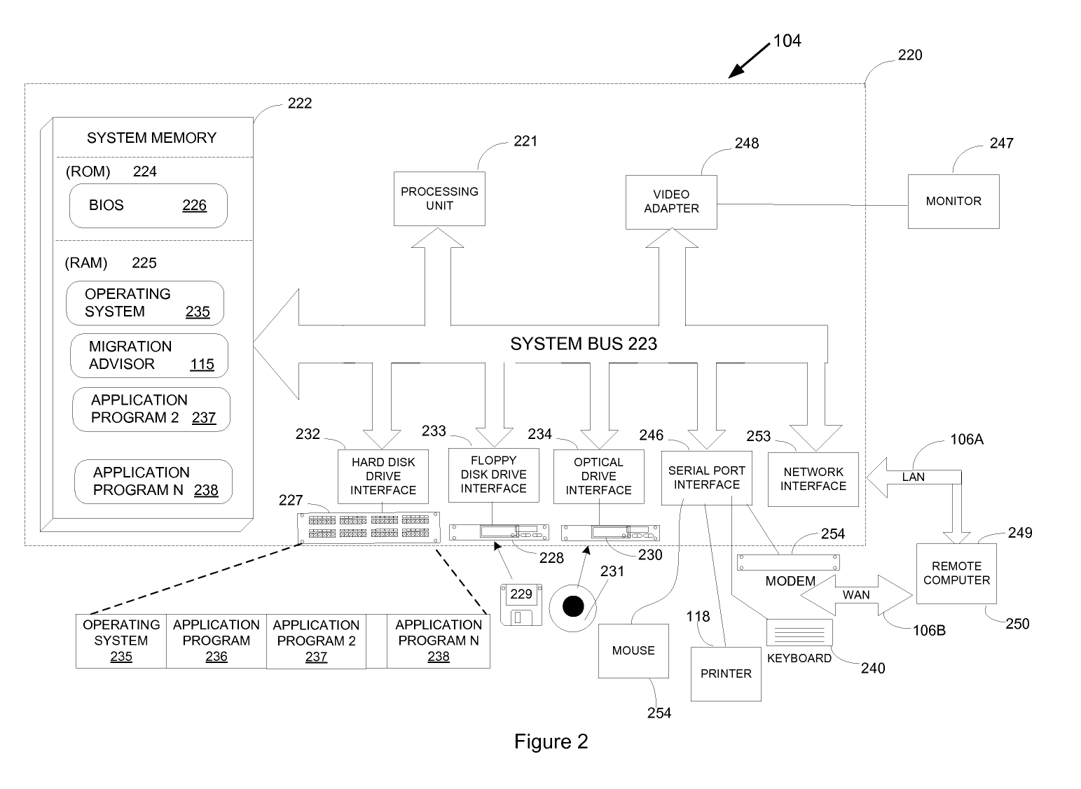

FIG. 2 is a block diagram illustrating a general component architecture for the network device 104, in accordance with certain exemplary embodiments. The network device 104 includes a general-purpose computing device in the form of a conventional computer 220. Generally, the computer 220 includes a processing unit 221, a system memory 222, and a system bus 223 that couples various system components, including the system memory 222, to the processing unit 221. The system bus 223 can include any of several types of bus structures, including a memory bus or memory controller, a peripheral bus, or a local bus, using any of a variety of bus architectures. The system memory 222 includes a read-only memory (“ROM”) 224 and a random access memory (“RAM”) 225. A basic input/output system (BIOS) 226 containing the basic routines that help to transfer information between elements within the computer 220, such as during start-up, is stored in the ROM 224.

The computer 220 also includes a hard disk drive 227 for reading from and writing to a hard disk (not shown), a magnetic disk drive 228 for reading from or writing to a removable magnetic disk 229 such as a floppy disk, and an optical disk drive 230 for reading from or writing to a removable optical disk 231 such as a CD-ROM, compact disk - read/write (CD/RW), DVD, or other optical media. The hard disk drive 227, magnetic disk drive 228, and optical disk drive 230 are connected to the system bus 223 by a hard disk drive interface 232, a magnetic disk drive interface 233, and an optical disk drive interface 234, respectively. Although the exemplary client device 104 employs a ROM 224, a RAM 225, a hard disk drive 227, a removable magnetic disk 229, and a removable optical disk 231, it should be appreciated by a person of ordinary skill in the art having the benefit of the present disclosure that other types of computer readable media also can be used in the exemplary client device 104. For example, the computer readable media can include any apparatus that can contain, store, communicate, propagate, or transport data for use by or in connection with one or more components of the computer 220, including any electronic, magnetic, optical, electromagnetic, infrared, or semiconductor system (or apparatus or device) or propagation medium, such as magnetic cassettes, flash memory cards, digital video disks, Bernoulli cartridges, and the like. The drives and their associated computer readable media can provide nonvolatile storage of computer-executable instructions, data structures, program modules, and other data for the computer 220.

A number of modules can be stored on the ROM 224, RAM 225, hard disk drive 227, magnetic disk 229, or optical disk 231, including an operating system 235 and various application modules 105, 237-238. Application modules 105 and 237-238 can include routines, sub-routines, programs, objects, components, data structures, etc., which perform particular tasks or implement particular abstract data types. Dojo module 105, is a modular open source JavaScript toolkit, or library, for use in the rapid development of JavaScript and/or Ajax-based applications on websites.

A user can enter commands and information to the computer 220 through input devices, such as a keyboard 240 and a pointing device 242. The pointing device 242 can include a mouse, a trackball, an electronic pen that can be used in conjunction with an electronic tablet, or any other input device known to a person of ordinary skill in the art, such as a microphone, joystick, game pad, satellite dish, scanner, or the like. These and other input devices are often connected to the processing unit 222 through a serial port interface 246 that is coupled to the system bus 223, but can be connected by other interfaces, such as a parallel port, game port, a universal serial bus (USB), or the like. A display device 247, such as a monitor, also can be connected to system bus 223 via an interface, such as a video adapter 248. In addition to the display device 247, the computer 220 can include other peripheral output devices, such as speakers (not shown) and a printer 118.

The computer 220 is configured to operate in a networked environment using logical connections to one or more remote computers 249, such as client devices 104 and application servers 103 and results servers 102. The remote computer 249 can be any network device, such as a personal computer, a server, a client, a router, a network PC, a peer device, or other device. While the remote computer 249 typically includes many or all of the elements described above relative to the computer 220, only a memory storage device 250 has been illustrated in FIG. 2 for simplicity. The logical connections depicted in FIG. 2 include a LAN 106A and a WAN 106B. Such networking environments are commonplace in offices, enterprise-wide computer networks, intranets, and the Internet.

When used in a LAN networking environment, the computer 220 is often connected to the LAN 106A through a network interface or adapter 253. When used in a WAN networking environment, the computer 220 typically includes a modem 254 or other means for establishing communications over the WAN 106B, such as the Internet. The modem 254, which can be internal or external, is connected to system bus 223 via a serial port interface 246. In a networked environment, program modules depicted relative to computer 220, or portions thereof, can be stored in the remote memory storage device 250.

It will be appreciated that the network connections shown are exemplary and other means of establishing a communications link between the computers can be used. Moreover, those skilled in the art will appreciate that the network device 104 illustrated in FIG. 2 can have any of several other suitable computer system configurations. For example, the network device 104 may not include certain components, in alternative exemplary embodiments. In certain exemplary embodiments, each of the network server devices 102-103 can include a structure similar to that described previously in connection with the network device 104.

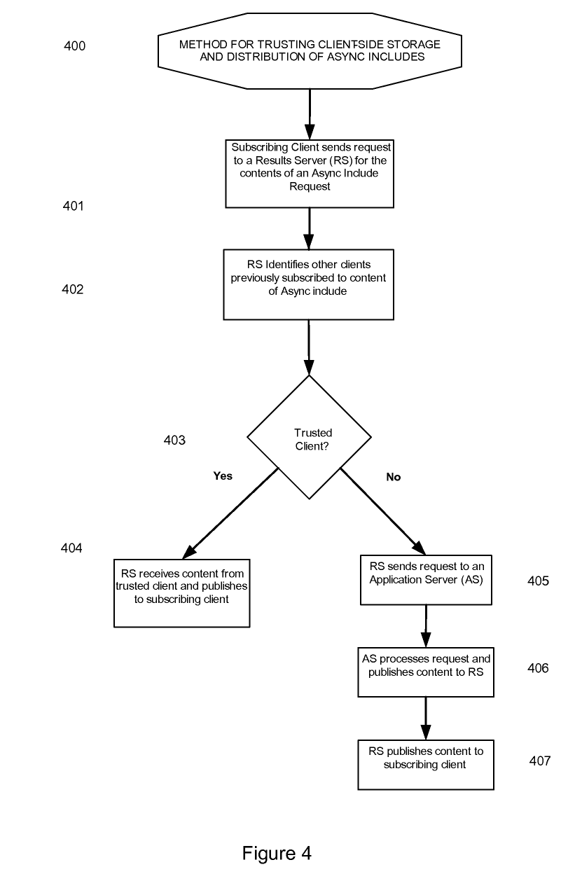

The application server environment 100, the application server 103, results server 102, and client devices 104 are described hereinafter with reference to the methods in FIG. 4.

FIG. 4 is a flow charts depicting a method for securing and validating client side storage and distribution of an asynchronous include requests, in accordance with certain exemplary embodiments. The exemplary method 400 is illustrative and, in alternative embodiments of the invention, certain steps can be performed in a different order, in parallel with one another, or omitted entirely, and/or certain additional steps can be performed without departing from the scope and spirit of the invention. The method 400 is described hereinafter with references to FIGS. 1-2 and 4.

In step 401, a first client device 104 (subscribing client) sends a request that contains one or more asynchronous includes to a results server 102.

The results server 102, then request the content of the asynchronous include in step 402, from a second client device 104 (publishing client) in the application server environment 100 that has previously subscribed to the content and stored the content in a local cache. The publishing client then publishes the content to the results server

In step 403, the application server 103 or request server 102 then verifies whether the publishing client is a trusted client of the requesting client. In a social networking application server environment the typical security model is a userid and password for each registered user. The registered user profile (userid and password for instance) are stored in a user registry. The user registry could be some such as LDAP, database, file system or some sort of custom repository such as OpenID where the user profile is some third party web site that is consider trusted. For the OpenID case, the present invention could determine whether the person is trusted based upon where the user got their OpenID URL from (such as myopenid.com or wordpress.com, or yahoo.com). The same would apply for a traditional enterprise (i.e. corporate environment) where an employee would be a registered user. LDAP is very popular in the enterprise since it is capable of representing users and groups. With the notion of groups, one can easily build a hierarchy demonstrating the corporate reporting structure and therein set trusted users for each client in an application server environment.

If the publishing client is a trusted client of the subscribing client, the results server 102 publishes the content to the subscribing client device 104 in step 404.

If the publishing client is not a trusted client of the subscribing client, the results server ignores the published content and repeats steps 402-403 until a trusted client is found.

If no trusted publishing clients with the requested content are available, the results server, in step 405, sends the original request from the subscribing client to an application server 103. In step 406, the application server 103 processes the request and publishes the content to the results server 102. In step 407, the results server publishes the requested content to the subscribing client 104.

The above description of illustrated embodiments of the invention, including what is described in the Abstract, is not intended to be exhaustive or to limit the embodiments to the precise forms disclosed. While specific embodiments of, and examples for, the inventions described herein for illustrative purposes, various equivalent modifications are possible, as those skilled in the art will recognize. These modifications can be made to embodiments of the invention in light of the above detailed description.

1. A method for trusting client-side storage and distributions of asynchronous include content requests in an application server environment, wherein the application server environment comprises an application server, a results server, and one or more clients, comprising the steps of:
a) sending a request with one or more asynchronous includes from a subscribing client to a results server,
b) the results server identifies additional clients in the application server environment which have previously subscribed to the content of the asynchronous include request,
c) the results server determines if any of the additional clients with the requested content are a trusted client of the subscribing client and if a trusted client is found, request the content from the trusted client,
d) the trusted client publishes the content of the asynchronous include requests to the results server and the results server publishes the content to the subscribing client,
if a trusted client with the content of the asynchronous content is not found in the application server environment, the results server requests the content of the asynchronous include request from the application server, the application server publishes the content of the asynchronous include to the results server, and the results server publishes the content to the subscribing client.
